(19) United States
(12) Patent Application Publication
(10) Pub. No.: US 2018/0035664 A1
(43) Pub. Date: Feb. 8, 2018

(54) MATERIAL FOR PACKAGING COMPRISING ANTIMICROBIAL COMPOSITION

(71) Applicant: Dow Global Technologies LLC, Midland, MI (US)

(72) Inventors: Paul R. Elowe, Arcadia, CA (US); Jaime L. Curtis-Fisk, Midland, MI (US); Cristina Serrat, Freeport, TX (US)

(21) Appl. No.: 15/549,285

(22) PCT Filed: Feb. 10, 2016
(86) PCT No.: PCT/US2016/017239

§ 371 Date: Aug. 7, 2017

Related U.S. Application Data
(60) Provisional application No. 62/128,954, filed on Mar. 5, 2015.

(51) Int. Cl. A01N 25/10; A01N 47/44; A01N 55/00; A01N 43/40

(52) U.S. Cl. CPC A01N 25/10; A01N 43/40; A01N 47/44; A01N 55/00

(57) ABSTRACT

Materials are provided that combine certain antimicrobial compositions with substrates to provide materials suitable for the packaging of food products, such as meat products. In one aspect, the present invention provides a material suitable for packaging that comprises (a) a substrate, and (b) an antimicrobial composition comprising: (i) an active antimicrobial agent and (ii) a carrier, wherein the antimicrobial composition has a viscosity of at least 50 centipoise at temperatures between 2° C. and 12° C.

### FIELD

The present invention relates to materials useful for packaging that comprise antimicrobial compositions. Such materials can be particularly useful in food packaging applications.

### INTRODUCTION

In the packaged food industry, particularly in the packaging of fresh meat in plastic materials, the protection of meat from bacteria and bacterial growth is very important to meat processors, packagers, and retailers. In the fresh meat space, cost effectiveness and long-lasting antimicrobial efficacy are important considerations. Most commercial antimicrobial technologies in the fresh beef, pork and poultry markets are carcass applications that utilize an antimicrobial spray or bath to apply the antimicrobial agent to the carcass.

It is desirable to provide multiple hurdles for pathogens along the supply chain in the preparation and packaging of fresh meats. As such, significant research has gone into developing antimicrobial solutions that are delivered along or with the packaging. A number of techniques have been attempted including, for example: incorporating an antimicrobial agent directly into a packaging material (e.g., via compounding or blending); immobilizing an antimicrobial agent onto the packaging (e.g., via surface treatment, reactive bonding, etc.), incorporating the antimicrobial agent via functionalization of the polymer resin (e.g., a quat polymer), and delivering the antimicrobial agent via a coating applied to the packaging surface. Each of these techniques has serious limitations. Incorporation of the antimicrobial agent into the packaging material is limited by the antimicrobial agent's temperature compatibility with extrusion temperatures (most organic antimicrobial agents are not compatible). Use of an antimicrobial agent (e.g., a temperature-stable metal-based particle such as silver) can result in the agent leaching out of the packaging material and onto the food. In addition, certain antimicrobial agents can induce changes to organoleptics (e.g., acids, essential oils, etc.) associated with the fresh meat. The functionalization of polymers to include functionalities with antimicrobial properties is typically not cost effective. Coating a packaging surface with an antimicrobial agent is also not effective as such coatings are typically aqueous-based and therefore drip off the surface of the foodstuff and collect in pockets in the package. Finally, immobilization of an antimicrobial agent onto a packaging substrate inherently reduces the mobility of the antimicrobial agent and affects efficacy.

It would thus be desirable to have alternative approaches for providing antimicrobial agents in food packages and in particular, packages of fresh meat.

### SUMMARY

The present invention's combination of certain antimicrobial compositions with substrates to provide materials suitable for packaging as described herein advantageously addresses many of the limitations associated with prior attempts to provide antimicrobial agents in food packaging. For example, in various embodiments, the present invention provides materials suitable for packaging that facilitate proper coverage of both packaging and food surfaces, with appropriate food contact times (significantly increased over aqueous-based systems), while maintaining mobility of the antimicrobial agent.

In one aspect, the present invention provides a material suitable for packaging that comprises (a) a substrate, and (b) an antimicrobial composition comprising: (i) an active antimicrobial agent and (ii) a carrier, wherein the antimicrobial composition has a viscosity of at least 50 centipoise at temperatures between 2° C. and 12° C. At such viscosities, the antimicrobial composition, delivered or carried by the packaging material in contact with the food (e.g., fresh meat), facilitates prolonged contact time for the active antimicrobial agent on the surface of the food. Furthermore, the active antimicrobial agent can remain fully mobile within the carrier's matrix, allowing it to freely travel to infection sites, and thus improve efficacy over alternative approaches.

These and other embodiments are described in more detail in the Detailed Description.

### BRIEF DESCRIPTION OF THE DRAWINGS

FIG. 1 is a bar graph illustrating the results of Example 1.

FIG. 2 is a bar graph illustrating the results of Example 2.

FIG. 3 is a bar graph illustrating the results of Example 3.

### DETAILED DESCRIPTION

Unless specified otherwise herein, percentages are weight percentages (wt %) and temperatures are in ° C. A “food surface” is an outer surface of any food product. Food products include, without limitation, meats, cheeses, fruits and vegetables. Meats are the flesh of animals intended for use as food. Animals include mammals (e.g., cows, pigs, sheep, buffalo, etc.), birds (e.g., chickens, turkeys, ducks, geese, etc.), fish and shellfish. Meats include fresh meats (e.g., animal carcasses, cut meat pieces, etc.), processed meats, and processed meat products, such as sausage, cured meats, meat spreads, deli meats, sliced meats, and ground meats. Such meats can include for example, fresh meats, processed meats, and processed meat products that are to be stored, transported, displayed, and/or sold under refrigerated conditions (e.g., at temperatures of 2 to 6° C.). A “meat surface” is an outer surface of any meat product.

Following slaughter of an animal, meats are typically processed in a variety of ways prior to packaging for sale to consumers. In the case of some meat products (e.g., steaks, chicken breasts, etc.), the meats may only be cut and trimmed to smaller sizes. As another example, meat products, such as deli meat, may be cut, seasoned, cooked, and then sliced. Meats can be prepared in a wide variety of other ways known to those of skill in the art. Once prepared and/or processed for preparation to sale to consumers, the meats are packaged in a variety of ways.

At some point, prior to or after packaging, the meats are refrigerated or frozen. The packaged meats desirably remain refrigerated or frozen until purchase and/or use by the consumer. In the case of refrigerated meats, the meats and packages containing meats are typically held between 2° C. and 6° C., often 4° C. This is often the situation for fresh meats to be sold in retail stores. In some situations, there may be variation in refrigeration temperatures along the supply chain (e.g., between a meat processor and a retail location) such that the storage temperature of the meat packages may be between 4° C. and 12° C. At temperatures within that range (2° C. and 12° C.), the potential for bacterial growth on the meat surface remains, even after packaging. Furthermore, it is well known in the field that the bacterial makeup on the meat surface can be vastly different between 2° C. and 12° C. than at other temperatures. Furthermore, the bacterial makeup on the meat surface is generally also vastly different across the temperature range of 2° C. and 12° C. Thus, embodiments of the present invention are directed toward materials suitable for packaging that can be used with packaged meat products to prevent and/or inhibit the growth of bacteria on the meat surface at temperatures between 2° C. and 12° C. Some embodiments of the present invention are directed toward materials suitable for packaging that can be used with packaged meat products to prevent and/or inhibit the growth of bacteria on the meat surface at a broad range of temperatures including temperatures less than 2° C. and/or greater than 12° C.

In one aspect, the present invention provides a material suitable for packaging that comprises (a) a substrate, and (b) an antimicrobial composition comprising: (i) an active antimicrobial agent and (ii) a carrier, wherein the antimicrobial composition has a viscosity of at least 50 centipoise at temperatures between 2° C. and 12° C. At such viscosities, the antimicrobial composition facilitates prolonged contact time for the active antimicrobial agent on the surface of the food. Furthermore, the active antimicrobial agent can remain fully mobile within the carrier's matrix, allowing it to freely travel to infection sites, and thus improve efficacy over alternative approaches. The upper limit of viscosity can vary depending on the particular antimicrobial composition. In general, for a particular antimicrobial composition, the viscosity will be too high if there is a significant impact on mobility and/or efficacy of the active antimicrobial agent used. Thus, in considering a target viscosity range for a particular antimicrobial composition, important factors will include, for example, the particular antimicrobial agent(s) used (including combinations of antimicrobial agents), the amount of antimicrobial agent used, the content and composition of the carrier, the surface area of the food item, and other factors. By way of example, in some embodiments, the antimicrobial composition can have a viscosity of up to 200,000 centipoise at temperatures between 2° C. and 12° C. As another example, in some embodiments where the active antimicrobial agent is cetyl pyridinium chloride, and the carrier is a cellulose ether polymer and water, the antimicrobial composition can have a viscosity of up to 200,000 centipoise at temperatures between 2° C. and 12° C. As used herein, and unless otherwise stated, all references to viscosity values refer to viscosities measured using an ARES RFS3 rheometer with a cup and bob fixture containing 17 mL of solution at a temperature of 4° C. and at a shear rate of 10 s⁻¹.

A number of active antimicrobial agents can be used as discussed further below. In addition, a number of carriers can be used as discussed further below. In some embodiments, the antimicrobial compositions further comprise an antioxidant, a surfactant, a stabilizer, a buffer, a scavenger (e.g., odor, oxygen, moisture, etc.), and other additives, as well combinations of different additives. The substrate is a polymeric film in some embodiments.

In some aspects, the present invention relates to a package comprising any of the materials suitable for packaging described herein. In some embodiments, the antimicrobial composition is applied to a surface of the substrate prior to assembly of the package. In other embodiments, the antimicrobial composition is applied to an inner surface of the substrate after assembly of the package. The package, in some further embodiments, comprises a food product, such as a meat product. In some embodiments, the antimicrobial composition is in contact with the food product. While the antimicrobial composition is in contact with the food product in some embodiments, the inner surface of the substrate forming part of the packaging material may not necessarily be in contact with the food product in some embodiments. For example, while the inner surface of the substrate (or a portion of the inner surface of the substrate) may not be in contact with the food product, the antimicrobial composition may still drip and spread across the surface of the food product over time. In other embodiments, the inner surface of the substrate (or a portion of the inner surface of the substrate), as well as the antimicrobial composition, may be in contact with the food product.

Materials of the present invention can be adapted to prevent or inhibit the growth of a variety of bacteria including, for example:
(a) Escherichia coli including Shiga Toxin producing Escherichia coli (STEC) (also including strains of Verotoxin-producing Escherichia coli that have been linked with the severe complication hemolytic-uremic syndrome (HUS)); enterohemorrhagic E. coli (EHEC), shiga-like toxin-producing E. coli (STEC or SLTEC) (the specific seven serogroups of STEC include (O157:H7, O26, O103, O45, O111, O121 and O145) of enterohemorrhagic E. coli that have been declared adulterants in non-intact raw beef by U.S. Department of Agriculture, hemolytic uremic syndrome-associated enterohemorrhagic E. coli (HUSEC) and verocytotoxin- or verotoxin-producing E. coli (VTEC);
(b) other Escherichia coli strains that have been variously referred to by other virulence properties, such as enteroinvasive (EIEC), enteropathogenic (EPEC), enterotoxigenic (ETEC), enteroaggregative (EAEC or EAgEC);
(c) Salmonella species, including, but not limited to Salmonella enterica strains with the following subspecies based on serotyping:
   Enteritidis, Kentucky, Typhimurium, Typhimurium Covariant V, Heidelberg, Hadar, Newport, Georgia, Agona, Grampian, Senftenberg, Alachua, Infantis, Reading, Schwarzengrund, Mbandaka, Montevideo, Berta and Thompson;
(d) Pseudomonas species (including P. fragi, P. lundensis, P. fluorescens);
(e) Campylobacter species (including Campylobacter jejuni);
(f) Clostridium perfringens; Clostridium botulinum;
(g) Listeria species (including Listeria monocytogenes);
(h) Shigella spp. (including serotypes A, B, C and D);
(i) Staphylococcus species including Staphylococcus aureus (including Methicillin resistant Staphylococcus and including species causing Staphylococcal enteritis;
(j) Streptococcus species;
(k) Vibrio species including Vibrios cholera (including serotypes 01 and non-O1, Vibrio parahaemolyticus, and Vibrio vulnificus);
(l) Yersinia species including Yersinia enterocolitica and Yersinia pseudotuberculosis;
(m) Acinetobacter species (including Ac. johnsoni);
(n) Moraxella species;
(o) Psychrobacter species (including Psychr. immobilis);
(p) Shewanella species (including Shewanella putrefaciens);
(q) Enterobacter species;
(r) Serratia species;
(s) Lactobacillus species; and/or
(t) Brochothrix thermosphacta.

A variety of active antimicrobial agents can be used in various embodiments to inhibit or prevent the growth of bacteria. One important factor in selecting an active antimicrobial agent is the type(s) of bacteria to be targeted with the antimicrobial composition.

In some embodiments, the active antimicrobial agent comprises one or more quaternary ammonium salts. Quaternary ammonium salts suitable for use in embodiments of the present invention include, for example, those effective in inhibiting growth of bacteria, including spoilage bacteria. Preferably, the quaternary ammonium salt has at least one aromatic substituent (e.g., pyridinium or benzyl). Preferably, the quaternary ammonium salt has at least one C₈-C₂₅ alkyl group, preferably C₁₀-C₂₀. An example of a quaternary ammonium salt that can be used in some embodiments is cetyl pyridinium chloride. Another example of a quaternary ammonium salt that can be used in some embodiments is dimethyloctadecyl[3-(trimethoxysilyl)propyl]ammonium chloride, which is a silyl quat. Preferred quaternary ammonium salts include those effective against preventing or inhibiting the growth of one or more of the bacteria listed above. One factor in selecting a particular quaternary ammonium salt for use in some embodiments of the present invention is the bacteria to be targeted.

In embodiments utilizing quaternary ammonium salts as an antimicrobial agent, it is applied to the food surface with a carrier (as described in more detail below) as part of an antimicrobial composition. Preferably, the liquid carrier is an aqueous medium. In one preferred embodiment, the aqueous medium is buffered, preferably to a pH from 4 to 9, preferably from 5 to 8.5, preferably from 6 to 8. The concentration of quaternary ammonium salt in the carrier can be selected based on its activity, the target viscosity of the antimicrobial composition, the amount and/or surface area of the food product, and other factors in accordance with the teachings herein.

In some embodiments, the active antimicrobial agent comprises one or more amino acid derivatives. Amino acid derivatives suitable for use in embodiments of the present invention include, for example, those effective in inhibiting growth of bacteria, including spoilage bacteria. One exemplary amino acid derivative that can be used in some embodiments is ethyl-N^{α}-lauroyl-L-arginate (CAS number 60372-77-2, as the HCl salt) (also known as lauric arginate). Preferred amino acid derivatives include those effective against preventing or inhibiting the growth of one or more of the bacteria listed above. One factor in selecting a particular amino acid derivative for use in some embodiments of the present invention is the bacteria to be targeted.

In embodiments utilizing lauric arginate as an antimicrobial agent, it is applied to the food surface with a carrier (as described in more detail below) as part of an antimicrobial composition. Preferably, the liquid carrier is an aqueous medium. The concentration of lauric arginate in the antimicrobial composition can be selected based on its activity, the target viscosity of the antimicrobial composition, the amount and/or surface area of the food product, and other factors in accordance with the teachings herein.

In some embodiments, the active antimicrobial agent comprises one or more organic acids. An “organic acid” is a compound containing carbon and hydrogen atoms and having a pKₐ (measured at room temperature) from 2 to 6, preferably from 2.5 to 5.5, preferably from 3 to 5. For example, organic acids that can be used in some embodiments include carboxylic acids. Organic acids suitable for use in embodiments of the present invention include, for example, those effective in inhibiting growth of bacteria, including spoilage bacteria. The organic acids may be partially or even completely in their ionized form, i.e., as their salts. Preferably, organic acids do not contain nitrogen atoms. More than one organic acid may be used in combination. Preferably, the organic acid has from two to ten carbon atoms, preferably from two to eight, preferably from three to six. Examples of organic acids that can be used in some embodiments include lactic acid, benzoic acid, sorbic acid, citric acid, acetic acid, propionic acid and octanoic acid. In some embodiments, the organic acid comprises lactic acid. Preferred organic acids include those effective against preventing or inhibiting the growth of one or more of the bacteria listed above. One factor in selecting a particular organic acid for use in some embodiments of the present invention is the bacteria to be targeted. In embodiments utilizing organic acids as an antimicrobial agent, it is applied to the food surface with a carrier (as described in more detail below) as part of an antimicrobial composition. Preferably, the liquid carrier is an aqueous medium. The concentration of organic acids in the antimicrobial composition can be selected based on its activity, the target viscosity of the antimicrobial composition, the amount and/or surface area of the food product, and other factors in accordance with the teachings herein.

In some embodiments, the active antimicrobial agent comprises one or more peptides. Peptides suitable for use in embodiments of the present invention include, for example, those effective in inhibiting growth of bacteria, including spoilage bacteria. Examples of peptides that can be used in some embodiments include, for example, nisin, epsilon-polylysine, bacteriocins and colicins; preferably nisin and epsilon-polylysine. Preferred peptides include those effective against preventing or inhibiting the growth of one or more of the bacteria listed above. One factor in selecting a particular peptide for use in some embodiments of the present invention is the bacteria to be targeted. In embodiments utilizing peptides as an antimicrobial agent, it is applied to the food surface with a carrier (as described in more detail below) as part of an antimicrobial composition. Preferably, the liquid carrier is an aqueous medium. The concentration of peptide in the antimicrobial composition can be selected based on its activity, the target viscosity of the antimicrobial composition, the amount and/or surface area of the food product, and other factors in accordance with the teachings herein.

In some embodiments, the active antimicrobial agent comprises a metal-based antimicrobial agent. Metal-based antimicrobial agents suitable for use in embodiments of the present invention include, for example, those effective in inhibiting growth of bacteria, including spoilage bacteria. Examples of such metal-based antimicrobial agents include in some embodiments silver-based antimicrobial agents, zinc-based antimicrobial agents, and copper-based antimicrobial agents. Such metal-based antimicrobial agents can be in any form known in the art to be suitable for food applications including, for example, metal salts, metal oxides, nanoparticles, metals supported onto inorganic materials such as zeolites and clays, and combinations thereof. Preferred metal-based antimicrobial agents include those effective against preventing or inhibiting the growth of one or more of the bacteria listed above. One factor in selecting a particular metal-based antimicrobial agent for use in some embodiments of the present invention is the bacteria to be targeted. In embodiments utilizing metal-based antimicrobial agents, it is applied to the food surface with a carrier (as described in more detail below) as part of an antimicrobial composition. Preferably, the liquid carrier is an aqueous medium. The concentration of metal-based antimicrobial agent in the carrier can be selected based on its activity, the target viscosity of the antimicrobial composition, the amount and/or surface area of the food product, and other factors in accordance with the teachings herein.

In some embodiments, the active antimicrobial agent comprises a bacteriophage. Bacteriophages suitable for use in some embodiments of the present invention include, for example, those effective in inhibiting growth of bacteria, including spoilage bacteria. Preferred bacteriophages include those effective against the bacteria previously listed. One factor in selecting a particular bacteriophage for use in some embodiments of the present invention is the bacteria to be targeted.

In embodiments utilizing bacteriophages as an antimicrobial agent, it is applied to the food surface with a carrier (as described in more detail below) as part of an antimicrobial composition. Preferably, the liquid carrier is an aqueous medium. In one preferred embodiment, the aqueous medium is buffered, preferably to a pH from 4 to 9, preferably from 5 to 8.5, preferably from 6 to 8. The concentration of bacteriophages in the antimicrobial composition can be selected based on its activity, the target viscosity of the antimicrobial composition, the amount and/or surface area of the food product, and other factors in accordance with the teachings herein.

In some embodiments, antimicrobial compositions of the present invention do not include a bacteriophage, or a combination of bacteriophages as the only active antimicrobial agent. For example, embodiments of the present invention are targeted at the prevention or inhibition of bacterial growth at lower temperatures (e.g., refrigeration temperatures of 2° C. to 12° C.). Bacteriophages are understood to be less effective at lower temperatures due to lower microbial activity which is required for bacteriophage propagation, such that their inclusion may be less desirable in some embodiments of the present invention. For example, a higher concentration of bacteriophage may be needed to obtain antibacterial activity equivalent to the activity at higher temperatures where the bacteria are active. Another limitation of bacteriophages is that a cocktail of many individual bacteriophages would be needed to target the broad range of bacteria that could found in meat packaging, as bacteriophages are specific to individual strains of bacteria. Thus, in some embodiments, to the extent that bacteriophages are used, one or more bacteriophages can be used in combination with another active antimicrobial agent disclosed herein that is not a bacteriophage. In some embodiments, an antimicrobial composition does not include any bacteriophages.

In addition to the above active antimicrobial agents, other active antimicrobial agents that are effective in preventing or inhibiting the growth of bacteria can also be used in some embodiments of the present invention. Examples of such active antimicrobial agents can include, for example, naturally-derived antimicrobial agents including essential oils, such as for instance Myristica fragrans, Origanum vulgare, Pelargonium graveolens, Piper nigrum, Syzygium aromaticum, Thymus vulgaris; essential oil extracts and other naturally-derived active ingredients, such as for instance borneol, δ-3-carene, carvacrol, carvacrol methyl ester, cis/trans-citral, eugenol, geraniol, thymol, α-terpineol, terpinen-4-ol, (±)-linalool, (−)-thujone, geranyl acetate, nerol, menthone, β-pinene, R(+)-limonene, α-pinene, α-terpinene, citronellal, p-cymene, cinnamaldehyde and bornyl acetate; inorganic salts, such as for instance sodium chloride, acidified sodium chlorite, calcium hypochlorite, sodium metasilicate and trisodium phosphate.

In some embodiments, combinations of active antimicrobial agents can be provided in antimicrobial compositions of the present invention. For example, certain active antimicrobial agents may be more effective against certain varieties of bacteria, such that a combination of antimicrobial agents can provide better efficacy against a wider range of bacteria. In some embodiments, an antimicrobial composition can comprise any two or more of the active antimicrobial agents disclosed herein. For example, an antimicrobial composition, in some embodiments, can comprise a bacteriophage and at least one other active antimicrobial agent disclosed herein. Persons skilled in the art can determine various combinations of active antimicrobial agents, relative amounts, and concentrations based on the teachings herein.

In accordance with the present invention, the active antimicrobial agent is provided in a carrier as an antimicrobial composition. It is important for the antimicrobial composition to have a sufficient viscosity to facilitate contact with a food product (e.g., a meat product) when provided with a substrate for a food packaging material. The viscosity of the antimicrobial composition can enable prolonged contact time between the active antimicrobial agent and the food or meat surface. Further, the viscosity of the antimicrobial composition can facilitate the ability of the active antimicrobial agent to remain fully mobile with the matrix of the carrier, allowing the agent to freely travel to infection sites.

As embodiments of the present invention are directed to materials suitable for the packaging of fresh meats that are to be processed, shipped, and/or stored at refrigerated temperatures (2° C. to 12° C.), antimicrobial compositions can advantageously have certain viscosities within that temperature range for the reasons set forth herein. The antimicrobial composition can have a viscosity of at least 50 centipoise at temperatures between 2° C. and 12° C. in some embodiments. In some embodiments, the antimicrobial composition can have a viscosity of at least 250 centipoise at temperatures between 2° C. and 12° C. The antimicrobial composition can have a viscosity of at least 500 centipoise at temperatures between 2° C. and 12° C. in some embodiments. As noted above, the upper limit of viscosity can vary depending on the particular antimicrobial composition. In general, for a particular antimicrobial composition, the composition will be too high if there is a significant impact on mobility and/or efficacy of the active antimicrobial agent used. Thus, in considering a target viscosity range for a particular antimicrobial composition, important factors will include, for example, the particular antimicrobial agent(s) used, the amount of antimicrobial agent used, the content and composition of the carrier, the surface area of the food item, and other factors. By way of example, in some embodiments, the antimicrobial composition can have a viscosity of 50 to 200,000 centipoise at temperatures between 2° C. and 12° C. in some embodiments.

In various embodiments of the present invention, the active antimicrobial agents are provided in a carrier to form the antimicrobial composition. The components of the carrier at the target temperature range are the key factors affecting the viscosity of the antimicrobial composition. The carrier preferably comprises water and a rheology modifier. Examples of rheology modifiers that can be included in various embodiments of the present invention include cellulose ether polymers, gelatin, pectin, xantham gum, guar gum, and other rheology modifiers that others skilled in the art can identify based on the teachings herein. The particular type of rheology modifier and amount can be selected so as to provide a viscosity within a preferred range in accordance with the present invention at temperatures between 2° C. and 12° C.

One particularly desirable rheology modifier for use in some embodiments of the present invention is a cellulose ether polymer. Examples of cellulose ether polymers that can be used in some embodiments of the present invention include methylcellulose polymers, hydroxypropyl methylcellulose polymers, and combinations thereof. Such cellulose ether polymers are commercially available from The Dow Chemical Company under the name METHOCEL™. Examples of commercially available cellulose ether polymers that can be used in embodiments of the present invention include METHOCEL™ E50 and METHOCEL™ A4 C, which are commercially available from The Dow Chemical Company. Another example of a cellulose ether polymer that can be used in embodiments of the present invention are the cellulose ether polymers described in U.S. Patent Publication No. 2013/0236512, which is hereby incorporated by reference.

The concentration of cellulose ether polymer that can be included in the antimicrobial composition can depend on the targeted viscosity of the composition, the type of cellulose ether polymer used, and the molecular weight of the cellulose ether polymer. Persons of skill in the art can determine the appropriate amount of cellulose ether polymer to use based on the teachings herein in view of the targeted viscosity of the composition, the type of cellulose ether polymer used, and the molecular weight of the cellulose ether polymer.

Carriers used in embodiments of the present invention can include other rheology modifiers. Such rheology modifiers can be provided in addition to cellulose ether polymers in some embodiments. In other embodiments, a cellulose ether polymer may not be present with such rheology modifiers. Such other rheology modifiers can be used in addition to water to comprise the carrier of the active antimicrobial agent in the antimicrobial composition. In general, the amount of rheology modifier relative to water can be determined using techniques known to those of skill in the art so as to provide a target viscosity (as described herein) at temperatures between 2° C. and 12° C.

In some embodiments, the rheology modifier can comprise gelatin. In general, any gelatin that is approved for use in food applications can be used. In embodiments utilizing gelatin as the rheology modifier, gelatin can be used in an amount so as to increase the viscosity to a target range at temperatures between 2° C. and 12° C. without forming a gel. Non-limiting examples of gelatins that can be used in some embodiments of the present invention include gelatin commercially available from Sigma-Aldrich Co. As noted above, the amount of gelatin in water can be selected so as to provide a viscosity of the antimicrobial composition within a target range (as described herein) at temperatures between 2° C. and 12° C.

Examples of other rheology modifiers that can be used in some embodiments of the present invention include pectin, xantham gum, guar gum, and others that persons of skill in the art can identify based on the teachings herein. The amount of such rheology modifiers in water can be selected so as to provide a viscosity of the antimicrobial composition within a target range (as described herein) at temperatures between 2° C. and 12° C.

As indicated above, the carrier can also comprise a plurality of rheology modifiers (e.g., combinations of those described herein) in addition to water. The particular rheology modifiers and relative amounts can be selected so as to provide a viscosity within a preferred range in accordance with the present invention at temperatures between 2° C. and 12° C., and so as to avoid potential compatibility issues that might impact the performance of the antimicrobial composition and the safety of the product.

In addition to water and rheology modifier(s), the carrier, in some embodiments, can comprise other ingredients. Such ingredients can include, for example, antioxidants, surfactants, stabilizers, buffers, scavengers (e.g., odor, oxygen, moisture, etc.), as well as others that persons of skill in the art can identify based on the disclosure herein. In some embodiments, solvents, such as glycol solvents (e.g., propylene glycol, or glycerol), can be included. Preferably, when solvents are included they are present in an amount no greater than 10 wt %, preferably no greater than 7 wt %, preferably no greater than 4 wt %, preferably no greater than 3 wt %, preferably no greater than 2 wt %.

Some embodiments of the invention will now be described in detail in the following Examples.

### EXAMPLES

Preparation of Antimicrobial Compositions

Many of the examples below discuss application of an active antimicrobial agent as part of a carrier that comprises water and a rheology modifier.

In some of the examples, the rheology modifier is a cellulose ether polymer (commercially available from The Dow Chemical Company as METHOCEL™ A400 AND METHOCEL™ E50 as specified, or as otherwise described in example). Stock solutions of methylcellulose are prepared by dispersing the specified METHOCEL™ solid polymer in hot water (at a temperature of at least 80° C.) while stirring to fully mix the polymer in the water. Stirring was then continued while the solution was cooled to 4° C. The solution is then stored overnight at 4° C. to complete the polymer hydration. The antimicrobial compositions are then prepared by mixing the methylcellulose stock solution with the specified active antimicrobial agents and water to achieve the desired concentrations. When indicated, viscosity was measured using an ARES RFS3 rheometer with a cup and bob fixture containing 17 mL of solution at a temperature of 4° C. and at a shear rate of 10 s⁻¹.

Efficacy Testing

The below examples evaluate the efficacy of some embodiments of antimicrobial compositions of the present invention as well as comparative examples. Unless otherwise described, the efficacy of the formulations are evaluated using chicken skin inoculated with the target bacteria as follows. Chicken skin is removed from chicken thighs purchased from a grocery store and rinsed in isopropyl alcohol followed by several washes with sterile phosphate buffered saline. An approximately 25 cm² piece of chicken skin is stapled to a foil pan for solid support. Any excess liquid is drained from the surface of the chicken skin. The chicken skin is inoculated by spreading 1 mL of a bacteria cell culture onto the surface and allowing the bacteria to soak on the surface for 30 minutes at the target testing temperature. For liquid/gel formulations, the solution is applied to the surface and covered with a round piece of polyethylene (DOWLEX™ 2045G) film having a diameter of 2.3 cm. After incubation at the target temperature (4° C. unless otherwise noted), samples of the chicken skin are removed using a sterile 5 mm round biopsy punch. Each sample is vortexed in 1 mL of TSB growth media for 30 seconds to remove the bacteria from the chicken surface. The bacteria concentration in the solution is then quantified via the Most Probable Number method of enumeration.

### Example 1

Chicken skin samples are inoculated with E. Coli 11303 and treated with a piece of polyethylene film (DOWLEX™ 2045G) under the following conditions:
Control: Polyethylene film with no active antimicrobial agent (“Control”);
Corona: Polyethylene film (DOWLEX™ 2045G) that is corona treated and soaked overnight in an aqueous solution having 2% of an active antimicrobial agent (either cetylpyridinium chloride (“CPC”), ethyl-N^{a}-lauroyl-L-arginate (“LEA”), or dimethyloctadecyl[3-(trimethoxysilyl)propyl]ammonium chloride (a silyl quat) (“SQ”), as specified below) (“Corona CPC”, “Corona LEA”, “Corona SQ”);
Water: One milliliter of an aqueous solution having 2% of an active antimicrobial agent (as specified below) dispensed on the chicken surface with a polyethylene film (DOWLEX™ 2045G) placed over the treatment (“CPC Water”, “LEA Water”, and “SQ Water”); and
Polymer (Antimicrobial Composition): One milliliter of a solution containing 2 weight % of an experimental methylcellulose polymer, and 2% of the specified active antimicrobial agent (the solution prepared as described above), were placed on the chicken surface and then a polyethylene film (DOWLEX™ 2045G) placed over the treatment (“CPC Polymer”, “LEA Polymer”, and “SQ Polymer”).

The experimental methylcellulose polymer is prepared as follows. Finely ground wood cellulose pulp is loaded into a jacketed, agitated reactor. The reactor is evacuated and purged with nitrogen to remove oxygen and then evacuated again. The reaction is carried out in two stages. In the first stage, a 50 weight percent aqueous solution of sodium hydroxide is sprayed onto the cellulose in an amount of 2.0 moles of sodium hydroxide per mole of anhydroglucose units in the cellulose and the temperature is adjusted to 40° C. After stiffing the mixture of aqueous sodium hydroxide solution and cellulose for about 20 minutes at 40° C., 1.5 moles of dimethyl ether, 2.5 moles of methyl chloride and 0.6 mols of propylene oxide per mole of anhydroglucose units are added to the reactor. The contents of the reactor are then heated in 60 min to 80° C. After having reached 80° C., the first stage reaction is allowed to proceed for 30 min. A second stage of the reaction is started by addition of methyl chloride in an amount of 2.8 molar equivalents of methyl chloride per mole of anhydroglucose units. The addition time for methyl chloride is 10 min. Then a 50 weight percent aqueous solution of sodium hydroxide at an amount of 2.3 moles of sodium hydroxide per mole of anhydroglucose units is added over a time period of 90 min. The rate of addition is 0.026 moles of sodium hydroxide per mole of anhydroglucose units per minute. After the second stage addition is completed the contents of the reactor are then kept at a temperature of 80° C. for 120 min. After the reaction, the reactor is vented and cooled down to about 50° C. The contents of the reactor are removed and transferred to a tank containing hot water. The crude methylcellulose is then neutralized with formic acid and washed chloride free with hot water (assessed by AgNO₃ flocculation test), cooled to room temperature and dried at 55° C. in an air-swept drier. The material is then ground using an Alpine UPZ mill using a 0.5 mm screen. In order to reduce the viscosity of the methylcellulose when put in solution, the methylcellulose is partially depolymerized. The methylcellulose is partially depolymerized by heating the powderous material with gaseous hydrogen chloride and then neutralizing with sodium bicarbonate. In general, partial depolymerization processes are well known in the art as set forth, for example, in U.S. Patent Publication No. 2013/0236512, at paragraphs [0048] and [0097] and Table 2.

The experimental methylcellulose polymer is characterized by its viscosity as a two weight percent solution in water measured at 20° C. The two percent by weight polymer solution is prepared and tested for viscosity according to U.S. Pharmacopeia (USP, “Methylcellulose”, pages 3776-3778). This viscosity is known herein as the “2% solution viscosity.” The experimental methylcellulose polymer had a 2% solution viscosity of 742 cP.

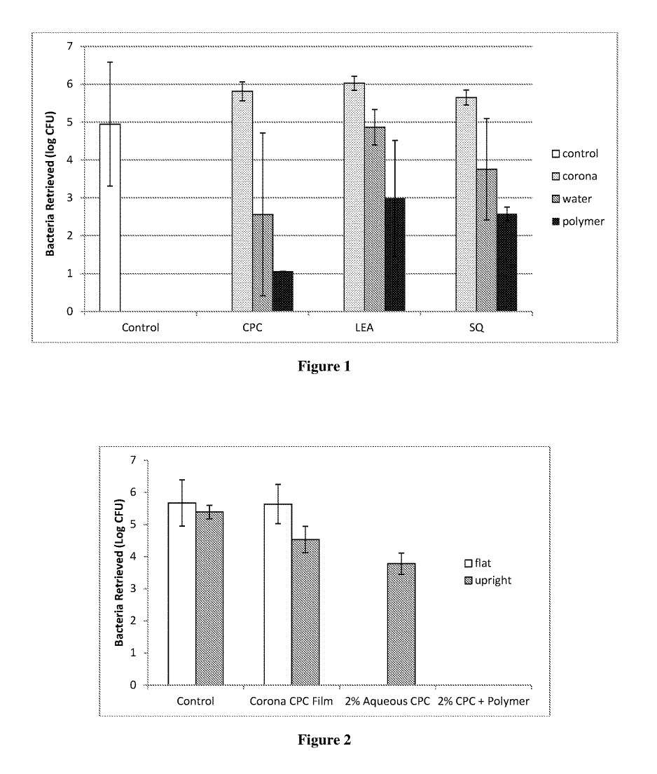

Three active antimicrobial agents are assessed: cetylpyridinium chloride (from Sigma-Aldrich Co. and also referred to herein as “CPC”), ethyl-N^{a}-lauroyl-L-arginate (also referred to herein as “lauric arginate” or “LEA”), and dimethyloctadecyl[3-(trimethoxysilyl) propyl]ammonium chloride (a silyl quat available from Sigma-Aldrich Co. and also referred to herein as “SQ”). Each of the treatment techniques is prepared in triplicate, and each technique is repeated on three separate pieces of chicken skin. After applying the treatment technique, the samples are stored at 4° C. overnight (about 18 hours). Four 5 mm round samples are removed from beneath the polyethylene film of each sample and vortexed in 1 mL of peptone buffered water for 30 seconds to remove bacteria. The quantity of surviving bacteria is determined using the Most Probably Number microtiter method. The results are displayed in FIG. 1. Each data set represents the four locations evaluated on each chicken skin sample, and as indicated, each treatment technique is evaluated on three chicken skin samples.

The “Control” samples are not treated and do not include any active antimicrobial agent. Overall, the antimicrobial compositions comprising the polymer (methylcellulose) show the greatest reduction in bacteria relative to the control. Visually, this is also observed as the antimicrobial compositions comprising the polymer (methylcellulose) remain in the locations where they are dispensed, while the water-based samples are spread across the chicken skin surface and settle in the low points of the chicken skin sample.

### Example 2

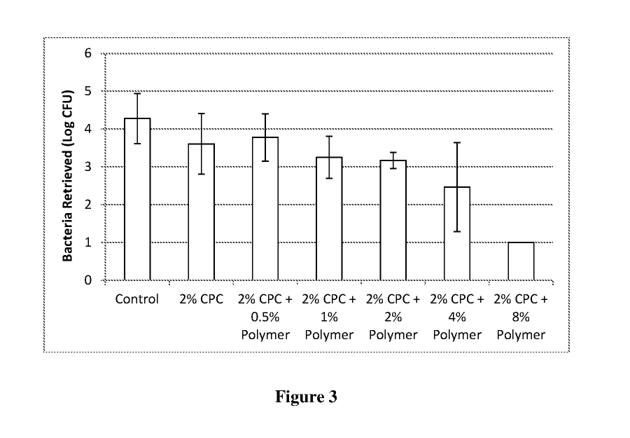

The approach described in Example 1 is further utilized to assess the impact of dripping on antimicrobial activity. Samples of chicken skin inoculated with E. Coli are treated with the CPC using three of the treatment techniques described in Example 1 (Corona (referred to as “Corona film” in FIG. 2), Water (referred to as “CPC-water” in FIG. 2), and Polymer (Antimicrobial Composition) (referred to as “CPC-polymer” in FIG. 2, and prepared as described in Example 1). One set of chicken skin samples remain flat during the overnight storage, and the other set are stored vertically (upright) during overnight storage to induce dripping. FIG. 3 illustrate the reduction in the level of bacteria observed. The samples treated with the corona-treated films (“corona film”) show very little bacteria reduction, while the Polymer (Antimicrobial Composition) treatment technique (“CPC-polymer”) samples show drastic bacteria reduction in both sample sets. A key difference is observed in the Water treatment technique samples (“CPC-water”) as the bacteria reduction is dramatically lower when dripping is induced (vertical orientation). It is visually observed that the solution in the Water treatment technique quickly flows from the chicken skin surface immediately after application of the solution on the upright sample.

### Example 3

This example evaluates the effect of viscosity of the antimicrobial composition on antimicrobial efficacy. The treatment techniques are evaluated as described in the “Efficacy Testing” section above. A control sample includes no rheology modifier and no active antimicrobial agent (“Control”). Antimicrobial compositions comprising CPC and a range of rheology modifier levels (a methylcellulose commercially available from the Dow Chemical Company as METHOCEL™ E50) are compared to an aqueous solution of CPC. FIG. 3 illustrates the results. The aqueous CPC solution (“Aqueous 2% CPC”) results in no significant decrease in bacteria. Likewise the solutions containing 0.5% rheology modifier (“2% CPC; 0.5% polymer”), 1% rheology modifier (“2% CPC; 1% polymer”), and 2% rheology modifier (“2% CPC; 2% polymer”) (with a viscosity around 74 cP) also do not show significant decreases in bacteria. At 4% rheology modifier (“2% CPC; 4% polymer”) (with a viscosity around 748 cP), the solution demonstrates increased efficacy, an effect that is even greater at 8% rheology modifier (“2% CPC; 8% polymer”) (with a viscosity around 11,600 cP).

1. A material suitable for food packaging, comprising:
(a) a polymeric film; and
(b) an antimicrobial composition comprising: (i) an active antimicrobial agent and (ii) a carrier, wherein the antimicrobial composition has a viscosity of at least 50 centipoise at temperatures between 2° C. and 12° C.

2. The material of claim 1, wherein the antimicrobial composition has a viscosity of up to 200,000 centipoise at temperatures between 2° C. and 12° C.

3. The material of claim 1, wherein the carrier comprises water and at least one of a cellulose ether polymer, gelatin, pectin, xantham gum, guar gum, and combinations thereof.

4. The material of claim 1, wherein the carrier comprises water and methylcellulose.

5. The material of claim 1, wherein the antimicrobial agent comprises at least one of an amino acid derivative, an organic acid, a peptide, a quaternary ammonium salt, an amino acid derivative, and combinations thereof.

6. The material of claim 1, wherein the antimicrobial agent comprises at least one of cetylpyridinium chloride, lauric arginate, and dimethyloctadecyl[3-(trimethoxysilyl)propyl]ammonium chloride.

7. The material of claim 1, wherein the antimicrobial agent comprises at least one bacteriophage and at least one other antimicrobial agent.

8. The material of claim 1, wherein the antimicrobial agent is not a bacteriophage.

9. The material of claim 1, wherein the antimicrobial composition further comprises at least one of an antioxidant, a surfactant, a stabilizer, a buffer, a scavenger, and combinations thereof.

10. (canceled)

11. A package comprising the material of claim 1.

12. The package of claim 11, wherein the antimicrobial composition is applied to a surface of the substrate prior to assembly of the package.

13. The package of claim 11, wherein the antimicrobial composition is applied to an inner surface of the substrate after assembly of the package.

14. The package of claim 11, further comprising a meat product.

15. The package of claim 14, wherein the antimicrobial composition is in contact with the meat product.
